(19) United States
(12) Patent Application Publication
(10) Pub. No.: US 2010/0188711 A1
(43) Pub. Date: Jul. 29, 2010

(54) TRANSFERRED DOCUMENT MANAGING APPARATUS, TRANSFERRED DOCUMENT MANAGING METHOD, AND COMPUTER-READABLE STORAGE MEDIUM

(75) Inventors: Yusuke Hamada, Saitama-ken (JP); Kazuhiro Ogura, Kanagawa-ken (JP); Shinji Makishima, Tokyo (JP); Akihiro Mizutani, Kanagawa-ken (JP); Toshihiro Ida, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/692,862

(22) Filed: Jan. 25, 2010

Related U.S. Application Data
(60) Provisional application No. 61/147,274, filed on Jan. 26, 2009.

(51) Int. Cl. G06K 15/02; G06F 3/12

(52) U.S. Cl. 358/3.28; 358/1.15

(57) ABSTRACT

Management of a transferred document in a unit of the number of copies is realized, if first transfer management information indicating information concerning transfer processing applied to an original document in the past is included in image data of the original document, the first transfer management information is acquired. Second transfer management information, which is obtained by adding information concerning transfer processing performed on the basis of the acquired image data to content indicated by the acquired first transfer management information, is separately generated according to the number of copies of transferred documents obtained by transferring the original document such that the second transfer management information is peculiar to each of the transferred documents. To a transferred document obtained by the transfer processing based on the acquired image data, the second transfer management information generated in association with the transferred document is granted.

### CROSS-REFERENCE TO RELATED APPLICATION

This application is based upon and claims the benefit of priority from: U.S. provisional application 61/147,274, filed on Jan. 26, 2009, the entire contents of each of which are incorporated herein by reference.

### TECHNICAL FIELD

This specification relates to a technique of managing a transferred document in a unit of the number of copies in an image forming apparatus.

### BACKGROUND

In the past, so-called copy processing for printing, on a recording medium, image data obtained by scanning an original document is performed. There is known a technique for granting, when the copy processing is performed, in order to improve trackability of a copied document obtained by the copy processing, transfer management information to the copied document (see, for example, JP-A-2008-11426, JP-A-2008-28694, and JP-A-2008-59213).

In JP-A-2008-28694, image data obtained by scanning or copying an original document is accumulated in a storage device such as a hard disk and, when the image data is printed on a sheet, a serial number is granted to the image data to store the number of issued copies. However, in the related art, when a copied document obtained by copying an original document is further scanned or copied, image information of the original document is stored in the hard disk as different image data. Therefore, in some cases, intended management cannot be performed.

Further, in the technique disclosed in JP-A-2008-28694, copied documents are managed only by granting peculiar serial numbers thereto. Therefore, it is impossible to learn which original document is copied to obtain a certain copied document.

JP-A-2008-59213 discloses a technique for, in copying original document embedded with a radio tag, embedding a so-called “electronic watermark” in the original document to perform copy generation management. However, in the technique disclosed in JP-A-2008-59213, since each print job is watermarked to perform copy generation management, copied documents cannot be managed one by one. In other words, in the technique disclosed in JP-A-2008-59213, it is impossible to grasp which original document is copied to obtain a certain copied document.

Furthermore, in the technique disclosed in JP-A-2008-11426, an original document as a copy source and a copied document are associated with each other in a unit of one page to perform copy management using an ID and copy time of an image forming apparatus as keys. However, the original document as the copy source cannot be specified only with the ID and the copy time of the image forming apparatus. Since user management is not performed, it is impossible to grasp who performed processing even if a copy history is searched through.

### SUMMARY

To solve the problems, this specification relates to a transferred document managing apparatus including: an image acquiring unit configured to acquire image data of an original document set as a target of transfer processing; a management-information analyzing unit configured to acquire, if first transfer management information indicating information concerning transfer processing applied to the original document in the past is included in the image data acquired by the image acquiring unit, the first transfer management information; a transfer-management-information creating unit configured to separately generate second transfer management information, which is obtained by adding information concerning transfer processing performed on the basis of the image data acquired by the image acquiring unit to content indicated by the first transfer management information acquired by the management-information analyzing unit, according to the number of copies of transferred documents obtained by transferring the original document such that the second transfer management information is peculiar to each of the transferred documents; and a management-information granting unit configured to grant, to a transferred document obtained by the transfer processing based on the image data acquired by the image acquiring unit, the second transfer management information generated by the transfer-management-information creating unit in association with the transferred document.

This specification relates to a transferred document managing method including: acquiring image data of an original document set as a target of transfer processing; acquiring, if first transfer management information indicating information concerning transfer processing applied to the original document in the past is included in the acquired image data, the first transfer management information; separately generating second transfer management information, which is obtained by adding information concerning transfer processing performed on the basis of the acquired image data to content indicated by the acquired first transfer management information, according to the number of copies of transferred documents obtained by transferring the original document such that the second transfer management information is peculiar to each of the transferred documents; and granting, to a transferred document obtained by the transfer processing based on the acquired image data, the second transfer management information generated in association with the transferred document.

This specification relates to a computer-readable storage medium having stored therein a computer program for causing a computer to execute processing for: acquiring image data of an original document set as a target of transfer processing; acquiring, if first transfer management information indicating information concerning transfer processing applied to the original document in the past is included in the acquired image data, the first transfer management information; separately generating second transfer management information, which is obtained by adding information concerning transfer processing performed on the basis of the acquired image data to content indicated by the acquired first transfer management information, according to the number of copies of transferred documents obtained by transferring the original document such that the second transfer management information is peculiar to each of the transferred documents; and granting, to a transferred document obtained by the transfer processing based on the acquired image data, the second transfer management information generated in association with the transferred document.

### DESCRIPTION OF THE DRAWINGS

FIG. 1 is a diagram of the system configuration of a transferred document managing system according to an embodiment of the present invention;

FIG. 2 is a functional block diagram for explaining functions included in a MFP 1 according to the embodiment;

FIG. 3 is a flowchart for explaining a flow of processing (a transferred document managing method) in the transferred document managing system;

FIG. 4 is an image diagram for explaining association among transferred documents to which transfer management information is granted as QR codes;

FIG. 5 is a diagram of an example of a data table in a transfer management information management database 4 during use of the OR codes;

FIG. 6 is a diagram of an example of a data table in a transfer management database 5 during use of the QR codes;

FIG. 7 is a diagram of an example of a data table in a document management database 7 during use of the QR codes;

FIG. 8 is a diagram of an example of a data table in a user management database 6 during use of the QR codes;

FIG. 9 is a diagram for explaining a method of granting actual transfer management information to a transferred document;

FIG. 10 is a diagram of a configuration for recording, in copy processing or scan processing, when the processing is applied to not all pages of a processing target original document, the indication to that effect as a log;

FIG. 11 is a diagram of a configuration for regarding, in copy processing or scan processing, when the processing is applied to not all pages of a processing target original document, that an error occurs and stopping the processing; and

FIG. 12 is a conceptual diagram indicating in which of apparatuses various kinds of processing such as “detection of transfer management information”, “replacement or grant of transfer management information”, and “management of various data” by a database can be executed.

### DETAILED DESCRIPTION

Embodiments of the present invention are explained below with reference to the accompanying drawings.

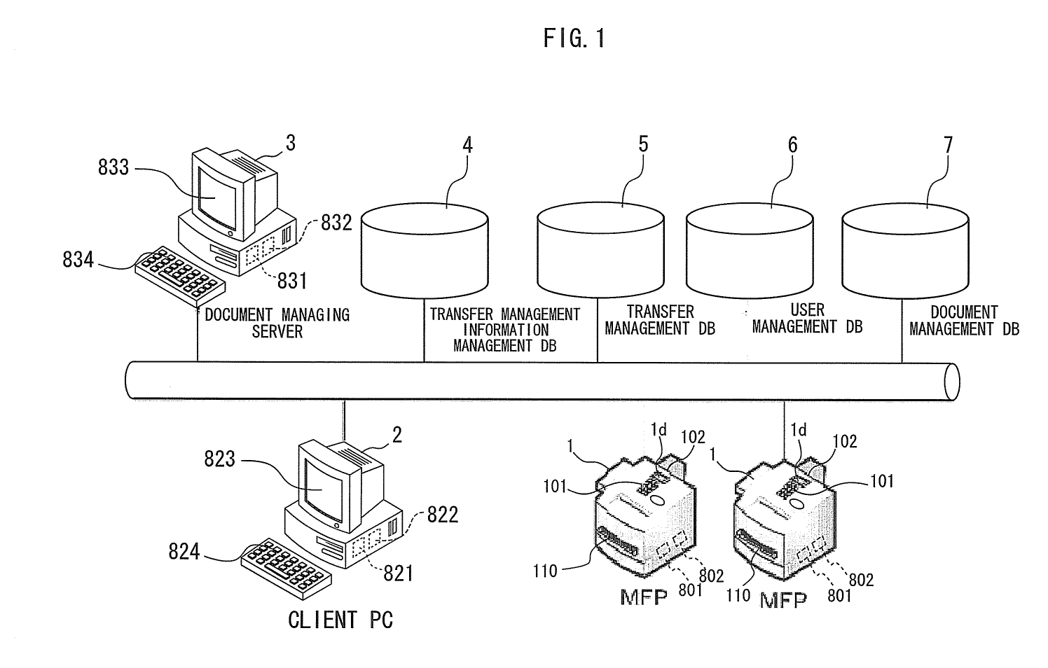

FIG. 1 is a diagram of the system configuration of a transferred document managing system according to an embodiment of the present invention.

The transferred document managing system according to this embodiment includes a MFP (Multi Function Peripheral) 1, a client PC (Personal Computer) 2, a document managing server 3, a transfer management information management database 4, a transfer management database 5, a user management database 6, and a document management database 7.

The MFP 1, the client PC 2, the document managing server 3, the transfer management information management database 4, the transfer management database 5, the user management database 6, and the document management database 7 are connected to be capable of communicating with one another through an electric communication line such as a LAN (Local Area Network).

The MFP 1 can perform image forming processing based on, for example, data transmitted from external apparatuses such as the document managing server 3 and the client PC 2 connected via a network, data stored in a portable storage medium connected to the MFP 1, image data obtained by scanning an original document in the MFP 1.

The client PC 2 instructs the MFP 1 to perform, for example, image forming processing based on image data and the like stored in storage areas of the document managing server 3 and the client PC 2.

The document managing server 3 can store, for example, document data that can be set as a target of the image forming processing in the MFP 1. A part of functions of the MFP 1 can also be realized by the document managing server 3.

The transfer management information management database 4 has a role of managing “transfer management information” explained later.

The transfer management database 5 manages, when a document image is transferred onto a recording medium, information indicating an original document used for processing for the transfer and information concerning a transferred document obtained by the transfer processing.

The user management database 6 manages “user information” serving as information for specifying a user who instructs the MFP 1 to execute transfer processing.

The document management database 7 manages a data group transferable onto a recording medium such as document data, text data, and image data.

An overview of the hardware configuration of the MFP 1 is explained below.

The MFP 1 includes an operation input unit 101, a reading unit 102, a display unit id, a printing unit 110, a CPU 801, and a memory 802.

The operation input unit 101 can include a keyboard, a mouse, a touch panel, a touch pad, and a graphics tablet. The operation input unit 101 receives an operation input of a user.

The reading unit 102 includes a scanner configured to optically read an original document in order to perform scan processing and copy processing.

The display unit 1d can include a LCD (Liquid Crystal Display), an EL (Electronic Luminescence) display, a PDP (Plasma Display Panel), and a CRT (Cathode Ray Tube) display.

The functions of the display unit 1d and the operation input unit 101 can also be realized by a so-called touch panel display.

The printing unit 110 forms a developer image such as a toner image on, for example, a sheet-like recording medium on the basis of image data read from an original document by the reading unit 102.

The CPU 801 has a role of performing various kinds of processing in the MFP 1. The CPU 801 also has a role of realizing various functions by executing a computer program stored in the memory 802. The memory 802 can include a RAM (Random Access Memory), a ROM (Read Only Memory), a DRAM (Dynamic Random Access Memory), a SRAM (Static Random Access Memory), or a VRAM (Video RAM). The memory 802 has a role of storing various kinds of information and computer programs used in the MFP 1.

The client PC 2 includes a CPU 821, a memory 822, a display unit 823, and an operation input unit 824. The document managing server 3 includes a CPU 831, a memory 832, a display unit 833, and an operation input unit 834.

The CPU 821 and the CPU 831 have functions same as those of the CPU 801. The memory 822 and the memory 832 have functions same as those of the memory 802.

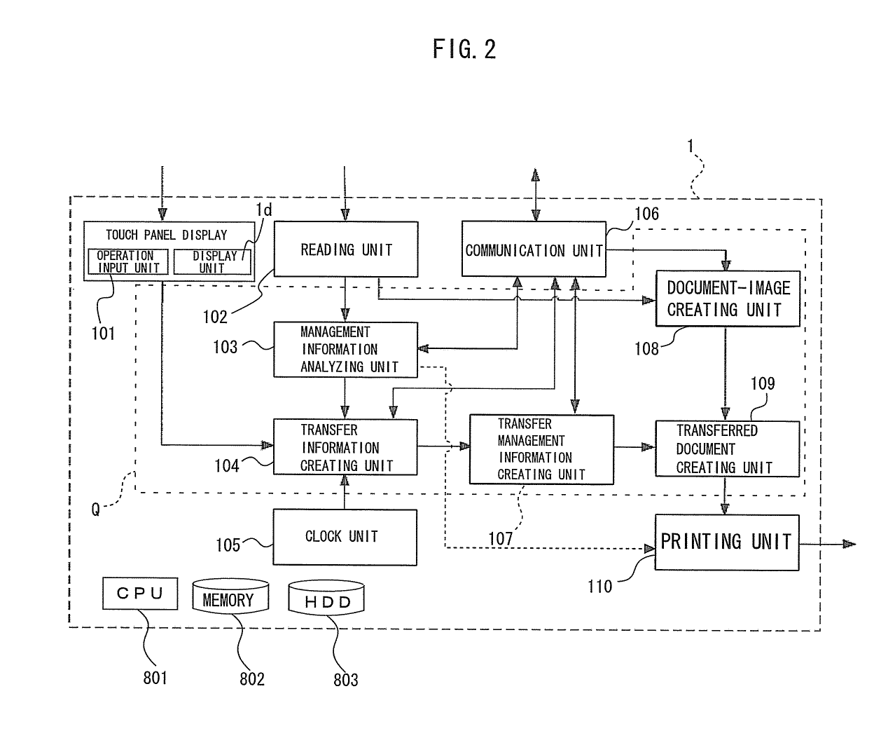

FIG. 2 is a functional block diagram for explaining functions included in the MFP 1 according to this embodiment.

In FIG. 2, hardware included in the MFP 1 and functions (functional blocks surrounded by a broken line Q) included in the MFP 1 are shown on the same figure in order to show a relation between the hardware and the functions. The functions surrounded by the broken line Q in FIG. 2 can be realized by, for example, loading a computer program stored in a HDD 803 to the memory 802 and causing the CPU 801 to execute the computer program.

The MFP 1 according to this embodiment includes an operation input unit 101, a reading unit (an image acquiring unit) 102, a management-information analyzing unit (a document-information acquiring unit and a transfer limiting unit) 103, a transfer-information creating unit (an operation-content acquiring unit) 104, a clock unit 105, a communication unit 106, a transfer-management-information creating unit (a management-information generating unit) 107, a document-image generating unit 108, a transferred-document creating unit (a management-information granting unit) 109, a printing unit 110, the CPU 801, the memory 802, and the HDD 803).

When processing that the MFP 1 is caused to execute is “scan” or “copy”, the reading unit (the image acquiring unit) 102 reads an “image” and “transfer management information” of an original document set as a target of the scan processing and copy processing (transfer processing). The user operates the operation input unit 101 to input an “ID”, a “password”, and the like for specifying the user.

In this embodiment, the “transfer processing” means processing involving print processing on a recording medium such as a recording sheet, for example, copy processing, print processing based on image data, and the like.

When processing that the MFP 1 is caused to execute is “print out”, the MFP 1 receives, in the communication unit 106, data as a print target transmitted from the client PC 2 or the document managing server 3 and extracts an “image” and “transfer management information” in the same manner as explained above.

The “transfer management information (first transfer management information)” means information concerning transfer processing applied in the past to an original document read by the reading unit 102 as a processing target.

Specifically, examples of the “transfer management information (first transfer management information)” include:

(1) information concerning an original document as a target of the transfer processing (a file name, a data size, data update date and time, latest access date and time, etc.);
(2) data of the original document as the target of the transfer processing (document data, image data, etc.);
(3) identification information of a user who instructs execution of the transfer processing (a user ID, an identification number, a user name, etc.);
(4) execution date and time of the transfer processing;
(5) a history of transfer management information granted in the past to the processing target original document;
(6) information indicating which copy of the original document a transferred document as a target of grant of the transfer management information is;
(7) information indicating the total number of pages of the original document;
(8) a limit number of times of copying of the original document;
(9) a limit number of times of printing of the original document; and
(10) a limit number of times of storage of image data obtained by scanning the original document.

The “image” acquired as explained above is passed to the document-image generating unit 108 and the “transfer management information” is passed to the management-information analyzing unit (the document-information acquiring unit) 103. If the transfer management information is included in the image of the processing target original document, the management-information analyzing unit 103 acquires the transfer management information as explained above. However, if the transfer management information is not included in the image, the processing proceeds to processing for creating transfer information explained later. When the “transfer management information” acquired by the management-information analyzing unit 103 is included in image data obtained by reading the original document, it is conceivable to include the “transfer management information” in a header or the like of the image data as meta data. It goes without saying that the “transfer management information” is not limited to this form. For example, the “transfer management information” may be associated with, for example, the image data of the original document.

The management-information analyzing unit 103 analyzes the “transfer management information” and passes a “document ID” and a “transfer management ID” to the transfer-information creating unit 104.

The clock unit 105 manages time on the inside of the MFP 1.

The transfer-information creating unit (the operation-content acquiring unit) 104 acquires the information passed from the management-information analyzing unit 103, time data acquired from the clock unit 105, and a user ID (in the case of scan processing or copy processing, acquired from the operation input unit 101 and, in the case of print out, acquired from the communication unit 106), shapes the information, the time data, and the user ID, and passes the same to the transfer-management-information creating unit 107. The transfer information creating unit (the operation-content acquiring unit) 104 passes data including the same content to the communication unit 106 and causes the communication unit 106 to register the data in the transfer management database 5. In this way, the transfer-information creating unit (the operation-content acquiring unit) 104 acquires input content of an operation input of the user.

The transfer-management-information creating unit (the management-information generating unit) 107 creates anew, on the basis of, for example, the information (the first transfer management information, etc.) passed from the transfer-information creating unit 104, “transfer management information (second transfer management information)” equivalent to a necessary number of copies according to the number of copies of the transferred document obtained by transferring the original document.

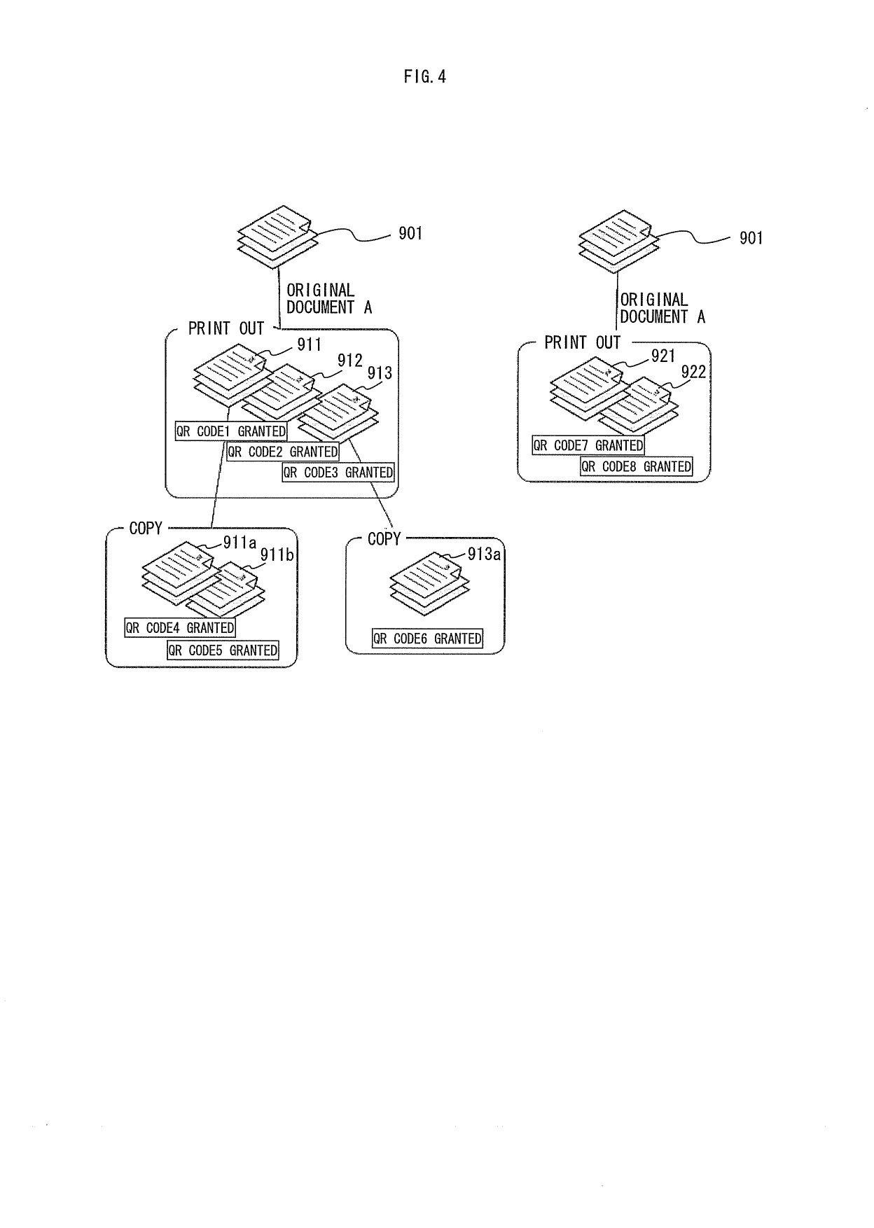

In this way, the transfer-management-information creating unit 107 separately generates the “second transfer management information”, which is obtained by adding the information concerning the transfer processing performed on the basis of the image data of the original document to the content indicated by the information (the first transfer management information, etc.) passed from the transfer-information creating unit 104, according to the number of copies of the transferred document obtained by transferring the original document such that the “second transfer management information” is peculiar to each of transferred documents (e.g., transferred documents 911 to 913 shown in FIG. 4 referred to later) (e.g., QR codes 1 to 3 shown in FIG. 4).

Examples of the transfer management information added to the transfer-management-information creating unit 107 anew include:

(1) identification information of a user who instructs execution of the transfer processing (a user ID, an identification number, a user name, etc.);
(2) execution date and time of the transfer processing;
(3) a history of transfer management information granted in the past to the processing target original document;
(4) information indicating which copy of the original document the transferred document as a target of grant of the transfer management information is;
(5) information indicating the total number of pages of the original document;
(6) a limit number of times of copying of the original document;
(7) a limit number of times of printing of the original document;
(8) a limit number of times of storage of image data obtained by scanning the original document; and
(9) information indicating a transferred document of which generation the original document is equivalent to (a cumulative number of transferred sheet concerning the original document/a limit number of sheets of transfer set for the original document).

The information (1) can be acquired from a login history or the like during network login by the user. The information (2) can be determined by acquiring, with the CPU 801, date and time and the like in the clock unit 105 at the time when an instruction for execution of the transfer processing is received by the MFP 1. The information (3) to (5) and (9) can be acquired from the various databases 4 to 7. The information (6) to (8) can be decided by acquiring, for example, setting content by an operation input to the operation input unit 101 by the user. The processing for determining the information (6) to (8) on the basis of the operation input by the user is performed when the information (6) to (8) is set anew for a transferred document or when the content is changed.

The transfer-management-information creating unit 107 passes the transfer management information created as explained above to the communication unit 106 and causes the communication unit 106 to register the transfer management information in the transfer management information management database 4.

The transferred-document creating unit (the management-information granting unit) 109 generates image data obtained by combining the “image of the original document” and the “transfer management information”. The printing unit 110 transfers the image data created by the transferred-document creating unit 109 to a recording medium readable by the MFP 1 such as a sheet (copy processing).

Specifically, the transferred-document creating unit 109 grants the second transfer management information, which is generated in association with the transferred document by the transfer-management-information creating unit 107, to a transferred document obtained by the transfer processing based on the image data acquired by the reading unit 102.

When an original document is transmitted from the client PC 2 to the MFP 1 and the original document is output by the MFP 1, even if the same original document is managed by the document management database 7, the original document is treated as an original document different from the already-managed original document and managed with new “transfer management information” granted thereto. Similarly, when an original document not granted with transfer management information is copied, even if the original document was copied before, the original document is managed as a different original document on the database.

A method of granting the “transfer management information” to the recording medium is realized by, for example, printing a part of or the entire “transfer management information” or information for specifying content of the “transfer management information” on the recording medium in a form of a “QR code”, a “barcode”, or the like or granting, as an “electronic watermark”, the “transfer management information” to a radio tag included in the recording medium.

When the “transfer management information” is granted to the recording medium in the MFP 1, the “transfer management information” may be visible or invisible on the recording medium. When an original document not granted with the “transfer management information” and output to the recording medium is present at hand, it is possible to grant the “transfer management information” to the transferred document by executing scan processing or copy processing in the MFP 1.

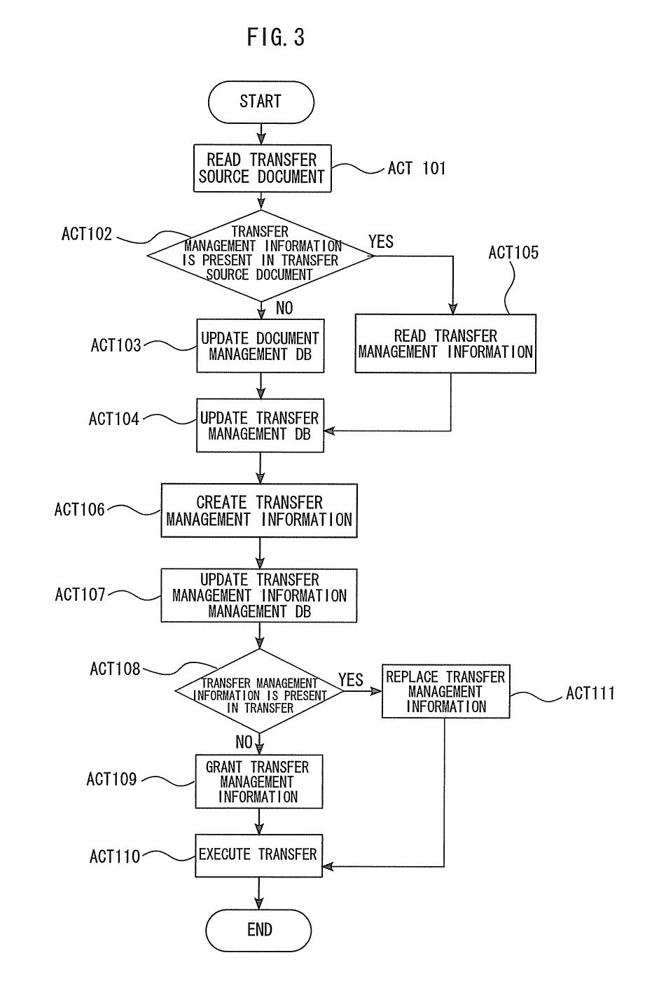

FIG. 3 is a flowchart for explaining a flow of the processing (the transferred document managing method) in the transferred document managing system.

In the flowchart shown in FIG. 3, a flow of processing in performing copy processing of an original document is explained.

First, the reading unit 102 scans a target original document of the copy processing (Act 101).

Subsequently, the management-information analyzing unit 103 determines whether the transfer management information (the first transfer management information) is included in image data obtained by reading an image from the original document (Act 102).

If the management-information analyzing unit 103 determines that the transfer management information is included in the image of the original document (Yes in Act 102), the management-information analyzing unit 103 acquires the transfer management information (Act 105).

On the other hand, if the management-information analyzing unit 103 determines that the transfer management information is not included in the image of the original document (No in Act 102), the management-information analyzing unit 103 communicates with the document management database 7 via the communication unit 106 and adds a “document ID”, a “document name”, and “document data” to content of the document management database 7 to update the content (Act 103). The management-information analyzing unit 103 communicates with the transfer management database 5 via the communication unit 106 and adds the “document ID”, an “old transfer management information ID”, a “user ID”, and “transfer time” to content of the transfer management database 5 to update the content (Act 104).

The transfer-management-information creating unit 107 creates second transfer management information anew on the basis of the transfer management information acquired as explained above and content of the copy processing about to be executed (Act 106).

The transfer-management-information creating unit 107 updates content of the transfer management information management database 4 on the basis of update contents in Act 104 and Act 106 (Act 107).

The transferred-document creating unit 109 determines whether the transfer management information is included in the image of the original document (Act 108). If the transfer management information is included in the image of the original document (Yes in Act 108), the transferred-document creating unit 109 replaces the first transfer management information included in the image of the original document with the second transfer management information generated anew (Act 111).

On the other hand, if the transfer management information is not included in the image of the original document (No in Act 108), the transferred-document creating unit 109 grants the transfer management information created anew to a recording medium to which the image scanned from the original document is transferred (Act 109).

Through the processing explained above, the printing unit 110 executes print processing on the recording medium (Act 110)

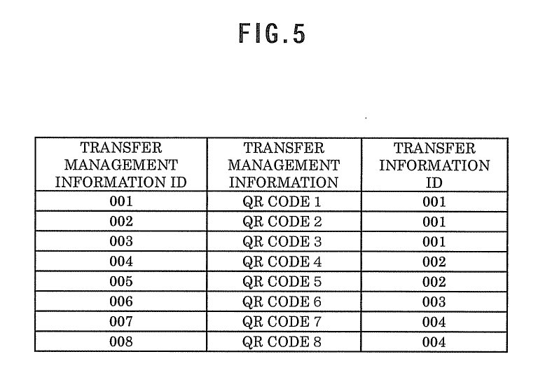

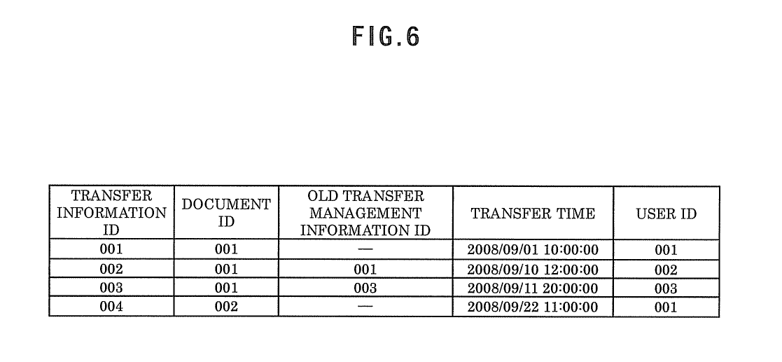

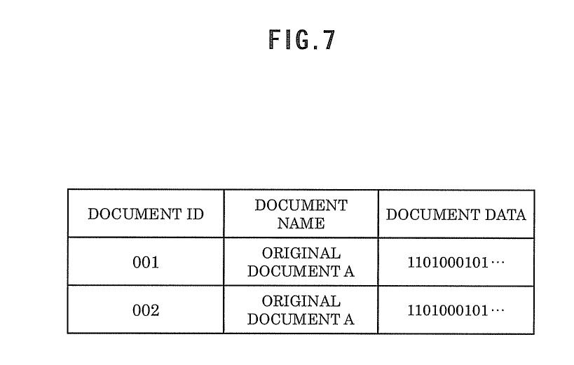

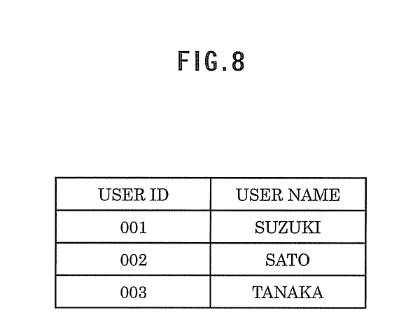

FIG. 4 is an image diagram for explaining association among transferred documents to which transfer management information is granted as QR codes. FIG. 5 is a diagram of an example of a data table in the transfer management information management database 4 during use of the QR codes. FIG. 6 is a diagram of an example of a data table in the transfer management database 5 during use of the QR codes. FIG. 7 is a diagram of an example of a data table in the document management database 7 during use of the QR codes. FIG. 8 is a diagram of an example of a data table in the user management database 6 during use of the QR codes.

In the image diagram shown in FIG. 4, when three copies of an original document A are printed out, a QR code 1 is granted to a transferred document 911, a QR code 2 is granted to a transferred document 912, and a QR code 3 is granted to a transferred document 913.

When two copies of the transferred document 911 of the first copy granted with the QR code 1 are made, the indication to the effect that such copy processing is performed is registered in the transfer management information management database 4 and the transfer management database 5. Transferred documents 911a and 911b are obtained by further copying the transferred document 911 in this way. A QR code 4 is granted to the transferred document 911a instead of the QR code 1. A QR code 5 is granted to the transferred document 911b instead of the QR code 1.

When one copy of the transferred document 913 granted with the QR code 3 is made, information registered in the databases 4 to 7 is updated. A transferred document 913a granted with a QR code 6 instead of the QR code 3 is output.

When two copies of the original document A are printed out again as transferred documents 921 and 922, as it is seen from the document management database 7, the transferred documents 921 and 922 are treated and managed as original documents different from the original document A.

To prevent this problem, for example, there is a method of collating an original document with document data managed in the document management database 7 using a file name or the like as a key and, when the same data is present, treating the original document as the same data without registering the original document in the document management database 7 anew. When there is no problem in terms of processing efficiency, a database size, and the like, improvement of collation accuracy can be realized by selecting a method of searching through all data contents as a method of collating document data.

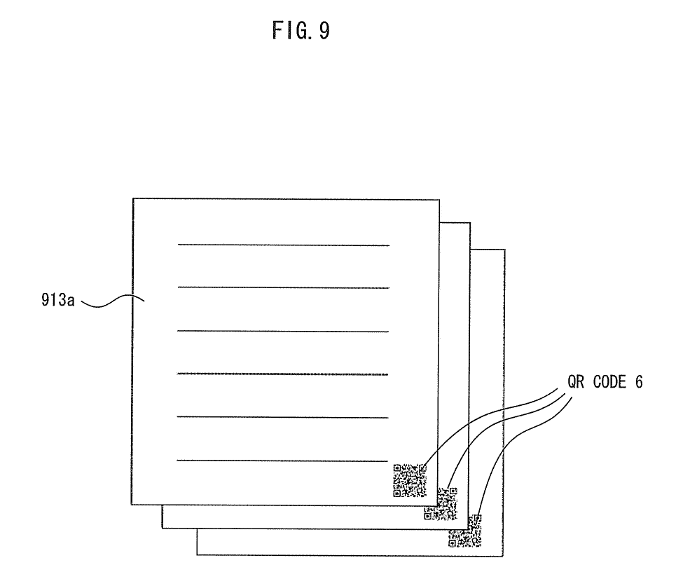

FIG. 9 is a diagram for explaining a method of granting actual transfer management information to a transferred document. As shown in the figure, in this embodiment, when a transferred document printed and output includes plural sheets, a QR code as transfer management information is granted to each of these plural pages. In FIG. 9, the QR code 6 is granted to respective pages of the transferred document 913a shown in FIG. 4.

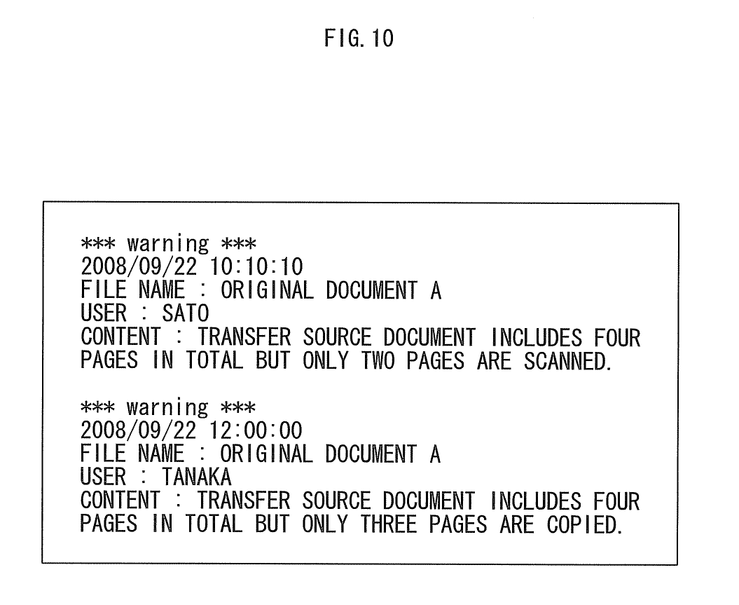

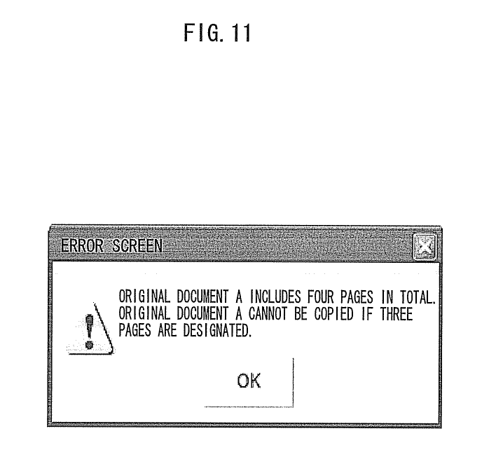

In the embodiment of the present invention, when copy processing or scan processing is performed, if the processing is applied to not all pages of a processing target original document, it is desirable to record the indication to that effect in a log as shown in FIG. 10 or regard this as an error and stop the processing as shown in FIG. 11.

Specifically, when copy processing about to be applied to an original document is processing for transferring the number of pages smaller than the “total number of pages of an original document” indicated by the transfer management information (the first transfer management information) acquired by the management-information analyzing unit (the document-information acquiring unit) 103, for example, the management-information analyzing unit (the transfer limiting unit) 103 prohibits execution of print processing for the original document by the printing unit 110.

Specifically, in FIG. 10, an error is recorded as a log because, for example, a user “Tanaka” attempts to copy the original document A, the total number of pages of which should be four, by only the number of pages smaller than four. Error information recorded as a log can be stored in, for example, the HDD 803 or the databases 4 to 7.

In FIG. 11, for example, an error notification screen is displayed on the display unit id because a user attempts to copy the original document A, the total number of pages of which should be four, by the number of pages smaller than four. The display of the error notification screen is performed by a display unit (e.g., the display unit 1d or the display unit 823) included in a terminal apparatus that instructs execution of the copy processing.

As explained above, according to this embodiment, a transferred document printed on a recording medium can be managed in a unit of the number of copies according to transfer management information. Therefore, if the indication indicating which copy of the transferred document is distributed to which user is stored in some storage device when the transferred document is distributed, for example, even if somebody leaves the transferred document behind, it is possible to determine who leaves the transferred document behind. Even if a transferred document that should be collected is not collected, it is possible to easily grasp who keeps the transferred document not collected.

As a method of recording the indication indicating which copy of an original document is distributed to which user, users may be allowed to arbitrarily record the indication in desired storage areas of the HDD 803 and the like or register the indication in the transfer management information management database 4.

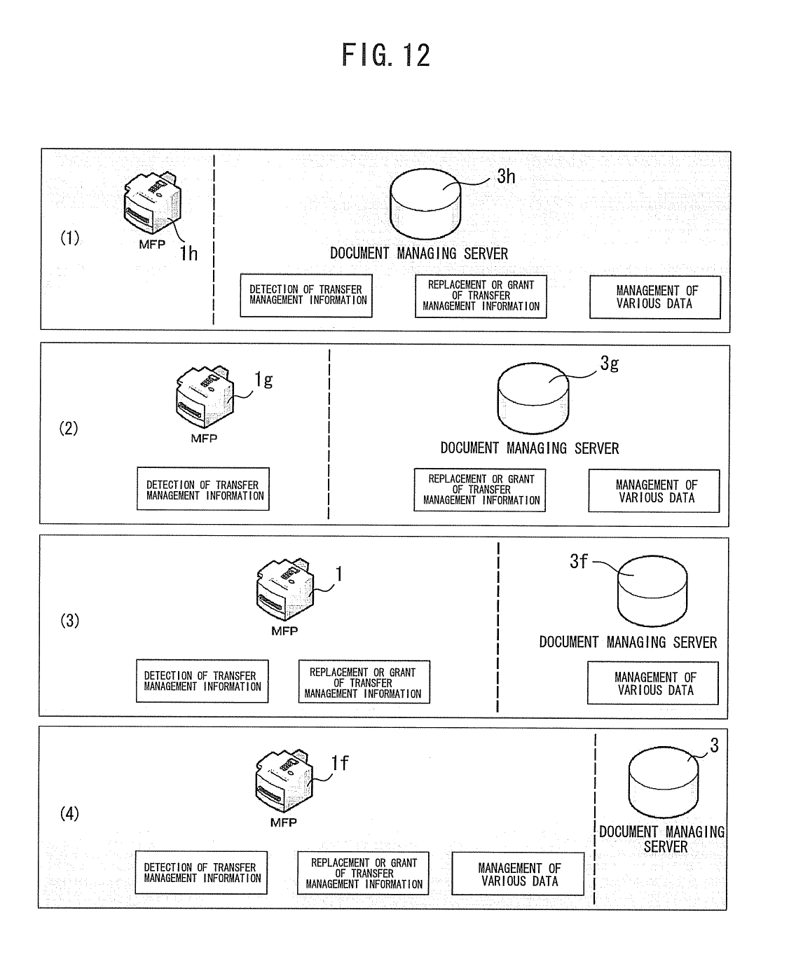

FIG. 12 is a conceptual diagram indicating in which of apparatuses various kinds of processing such as “detection of transfer management information”, “replacement or grant of transfer management information”, and “management of various data” by a database can be executed. Specifically, the “detection of transfer management information” is equivalent to, for example, acquisition of transfer management information by the management-information analyzing unit 103.

The “replacement or grant of transfer management information” is equivalent to, for example, replacement of old transfer management information with new transfer management information or grant of new transfer management information by the transfer-management-information creating unit 107.

As shown in the figure, examples of a distribution pattern of functions of the transferred document managing apparatus include four patterns.

In (1) in FIG. 12, all components included in the transferred document managing apparatus according to the embodiment of the present invention are provided in a document managing server 3h. When all the components included in the transferred document managing apparatus are provided in the document managing server 3h as shown in (1) in FIG. 12, there is an advantage that it is unnecessary to add special functions to a MFP 1h and the transferred document managing system according to the present invention can be realized even if an existing MFP is used.

In (2) in FIG. 12, a function of performing the “detection of transfer management information” in the transferred document managing system according to the embodiment of the present invention is provided in a MFP 1g and the other components included in the transferred document managing apparatus are provided in a document managing server 3g.

In (3) in FIG. 12, a function of performing the “detection of transfer management information” and a function of performing the “replacement or grant of transfer management information” in the transferred document management system according to the embodiment of the present invention are provided in the MFP 1. The configuration of the functional block diagram shown in FIG. 2 is equivalent to the function distribution shown in (3) in FIG. 12.

In (4) in FIG. 12, all the functions in the transferred document managing system according to the embodiment of the present invention are provided in a MFP if. In this case, the functions of the databases 3 to 7 can be realized by a HDD or the like included in the MFP 1f.

If transfer processing about to be applied to an original document exceeds a limit number of times of transfer indicated by information concerning a limit number of times of transfer included in the first transfer management information acquired by the document-information acquiring unit, the management-information analyzing unit (the transfer limiting unit) 103 can prohibit execution of the transfer processing for the original document.

The determination on how many times transfer of a certain document is performed can be realized by checking transfer management information registered as a history in, for example, the transfer management database 5. It is possible to grasp the number of times of transfer in the past of a certain original document without accessing an external database by causing the HDD 803 included in the MFP 1 to store the transfer management information as a history of transfer processing.

The determination on how many times transfer of a certain document is performed may be performed by, for example, including information indicating a cumulative number of times of transfer of the original document in transfer management information and, every time the transfer processing is applied to the original document, integrating the information indicating the cumulative number of times of transfer. Consequently, it is possible to grasp, simply by checking transfer management information attached to a transfer target original document, a cumulative number of times of transfer for the original document without accessing a server or a database.

When the transfer-information creating unit (the operation-content acquiring unit) 104 acquires operation input content indicating that a part of or the entire second transfer management information is not granted to a transferred document, the transferred-document creating unit (the management-information granting unit) 109 can prevent a part of or the entire second transfer management information from being granted to the transferred document.

For example, if not desiring to grant transfer management information to a transferred document, a user having predetermined authority concerning the transfer management information can transfer, by performing predetermined operation input such as password input in the operation input unit 101, an original document to a recording medium without granting the transfer management information to the original document.

When plural copies of transferred document are created from an original document, for example, limit numbers of sheets of transfer may be separately set to be different in a first copy of the transferred document and a second copy of the transferred document. Consequently, for example, when a person who receives the first copy of the transferred document and a person who receives the second copy of the transferred document have different authorities, it is possible to separately set limit numbers of sheets of transfer corresponding to the authorities.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (a CD-ROM, a CD-R, a DVD, and so on), and optical magnetic disk (a MD and so on) can be used to store instructions for causing a processor or a computer to perform the processes described above. Furthermore, based on an indication of the program installed from the memory device to the computer, an OS (operation system) operating on the computer, or MW (middleware software), such as database management software or network, may execute one part of each processing to realize the embodiments.

The present invention can be carried out in various other forms without departing from the spirit and the main characteristics thereof. Therefore, the embodiment is merely an illustration in every aspect and should not be limitedly interpreted. The scope of the present invention is indicated by the scope of claims and by no means is restricted by the text of the specification. Further, all modifications and various improvements, substitutions, and alterations belonging to the scope of equivalents of the scope of claims are within the scope of the present invention.

As explained above in detail, it is possible to realize management in a unit of the number of copies of a transferred document.

What is claimed is:

1. A transferred document managing apparatus comprising:
an image acquiring unit configured to acquire image data of an original document set as a target of transfer processing;
a management-information analyzing unit configured to acquire, if first transfer management information indicating information concerning transfer processing applied to the original document in the past is included in the image data acquired by the image acquiring unit, the first transfer management information;
a transfer-management-information creating unit configured to separately generate second transfer management information, which is obtained by adding information concerning transfer processing performed on the basis of the image data acquired by the image acquiring unit to content indicated by the first transfer management information acquired by the management-information analyzing unit, according to a number of copies of transferred documents obtained by transferring the original document such that the second transfer management information is peculiar to each of the transferred documents; and
a management-information granting unit configured to grant, to a transferred document obtained by the transfer processing based on the image data acquired by the image acquiring unit, the second transfer management information generated by the transfer-management-information creating unit in association with the transferred document.

2. The apparatus according to claim 1, wherein
the management-information analyzing unit includes a document-information acquiring unit configured to acquire the first transfer management information, and
the transfer-management-information creating unit includes a management-information generating unit configured to generate the second transfer management information.

3. The apparatus according to claim 2, wherein the first transfer management information and the second transfer management information are any one of information concerning the original document set as the target of the transfer processing, data of the original document set as the target of the transfer processing, identification information of a user who instructs execution of the transfer processing, execution time of the transfer processing, a history of transfer management information granted in the past to the target original document, and information indicating which copy of the transferred document a transferred document as a target of grant of the transfer management information is.

4. The apparatus according to claim 2, wherein the management-information granting unit grants the second transfer management information to the transferred document as anyone of a QR code, a barcode, and an electronic watermark.

5. The apparatus according to claim 4, further comprising a printing unit configured to transfer the second transfer management information granted by the management-information granting unit to a sheet-like recording medium with the second transfer management information included in image information that should be printed.

6. The apparatus according to claim 2, further comprising a transfer limiting unit configured to prohibit, if transfer processing about to be applied to the original document exceeds a limit number of times of transfer indicated by information concerning the limit number of times of transfer of the original document included in the first transfer management information acquired by the document-information acquiring unit, execution of the transfer processing for the original document.

7. The apparatus according to claim 2, further comprising a transfer limiting unit configured to prohibit, if transfer processing about to be applied to the original document is different from a total number of pages of the original document included in the first transfer management information acquired by the document-information acquiring unit, execution of the transfer processing for the original document.

8. The apparatus according to claim 7, wherein the transfer limiting unit prohibits, if the transfer processing about to be applied to the original document is processing for transferring a number of pages smaller than the total number of pages of the original document included in the first transfer management information acquired by the document-information acquiring unit, execution of the transfer processing for the original document.

9. The apparatus according to claim 2, further comprising an operation-content acquiring unit configured to acquire input content of operation input by a user.

10. The apparatus according to claim 9, wherein the management-information granting unit omits, if the operation-content acquiring unit acquires operation input content indicating that a part of or the entire second transfer management information is not granted to the transferred document, grant of the part of or the entire second transfer management information to the transferred document.

11. A transferred document managing method comprising:
acquiring image data of an original document set as a target of transfer processing;
acquiring, when first transfer management information indicating information concerning transfer processing applied to the original document in the past is included in the acquired image data, the first transfer management information;
separately generating second transfer management information, which is obtained by adding information concerning transfer processing performed on the basis of the acquired image data to content indicated by the acquired first transfer management information, according to a number of copies of transferred documents obtained by transferring the original document such that the second transfer management information is peculiar to each of the transferred documents; and
granting, to a transferred document obtained by the transfer processing based on the acquired image data, the second transfer management information generated in association with the transferred document.

12. The method according to claim 11, wherein the first transfer management information and the second transfer management information are any one of information concerning the original document set as the target of the transfer processing, data of the original document set as the target of the transfer processing, identification information of a user who instructs execution of the transfer processing, execution time of the transfer processing, a history of transfer management information granted in the past to the target original document, and information indicating which copy of the transferred document a transferred document as a target of grant of the transfer management information is.

13. The method according to claim 11, further comprising granting the second transfer management information to the transferred document as any one of a QR code, a barcode, and an electronic watermark.

14. The method according to claim 13, further comprising transferring the granted second transfer management information to a sheet-like recording medium with the second transfer management information included in image information that should be printed.

15. The method according to claim 11, further comprising prohibiting, when transfer processing about to be applied to the original document exceeds a limit number of times of transfer indicated by information concerning the limit number of times of transfer of the original document included in the acquired first transfer management information, execution of the transfer processing for the original document.

16. The method according to claim 11, further comprising prohibiting, when transfer processing about to be applied to the original document is processing for transferring the number of pages smaller than a total number of pages of the original document included in the acquired first transfer management information, execution of the transfer processing for the original document.

17. A computer-readable storage medium having stored therein a computer program for causing a computer to execute processing for:
acquiring image data of an original document set as a target of transfer processing;
acquiring, when first transfer management information indicating information concerning transfer processing applied to the original document in the past is included in the acquired image data, the first transfer management information;
separately generating second transfer management information, which is obtained by adding information concerning transfer processing performed on the basis of the acquired image data to content indicated by the acquired first transfer management information, according to a number of copies of transferred documents obtained by transferring the original document such that the second transfer management information is peculiar to each of the transferred documents; and
granting, to a transferred document obtained by the transfer processing based on the acquired image data, the second transfer management information generated in association with the transferred document.

18. The storage medium according to claim 17, wherein the computer program further causes the computer to execute processing for prohibiting, when transfer processing about to be applied to the original document exceeds a limit number of times of transfer indicated by information concerning the limit number of times of transfer of the original document included in the acquired first transfer management information, execution of the transfer processing for the original document.

19. The storage medium according to claim 17, wherein the computer program further causes the computer to execute processing for prohibiting, when transfer processing about to be applied to the original document is processing for transferring the number of pages smaller than a total number of pages of the original document included in the acquired first transfer management information, execution of the transfer processing for the original document.
